(19) United States
(12) Patent Application Publication
(10) Pub. No.: US 2026/0016843 A1
(43) Pub. Date: Jan. 15, 2026

(54) SELF-SUPPORTING SEGMENTED BLADDERS FOR REMOTE SENSING

(71) Applicant: MISSION SUPPORT AND TEST SERVICES, LLC, Las Vegas, NV (US)

(72) Inventors: Ian Bortins, Santa Barbara, CA (US); John Jacksen, Santa Barbara, CA (US); Elena Albregts, Santa Barbara, CA (US); Saketh Ayyalasomayajula, Santa Barbara, CA (US)

(21) Appl. No.: 19/265,814

(22) Filed: Jul. 10, 2025

Related U.S. Application Data
(60) Provisional application No. 63/670,699, filed on Jul. 12, 2024.

(51) Int. Cl. G05D 16/20

(52) U.S. Cl. CPC G05D 16/2013; G05D 16/2093

(57) ABSTRACT

Provided is a system and method that allows for the dispensing of corrosive gases into a vessel at low pressures. Examples provided include a method for storing low pressure gas including: receiving a gas within a bladder at least partially confined within a vessel; pressing the bladder against at least one wall of the vessel based on a pressure of the gas within the bladder; receiving, at a controller, a signal from at least one sensor disposed between the bladder and the at least one wall of the vessel; and controlling, with the controller, gas flow from a gas source into the bladder based on the signal from the at least one sensor disposed between the bladder and the at least one wall of the vessel.

### STATEMENT REGARDING FEDERAL RIGHTS

This invention mas made with government support under Contract No. NNSS Prime Contract DE-NA0003624 effective December 1, 2017, and was awarded by the U.S. Department of Energy, National Nuclear Security Administration. The government has certain rights in the invention.

### CROSS-REFERENCE TO RELATED APPLICATIONS

This application claims priority to U.S. Provisional Patent Application Serial No. 63/670,699, filed on July 12, 2024, the contents of which are herein incorporated by reference in their entirety.

### TECHNOLOGICAL FIELD

Embodiments of the present disclosure relate generally to a system and method that allows for the dispensing of corrosive gases into a vessel at low pressures.

### BACKGROUND

Corrosive gases can react with materials creating unexpected hazards. Control of corrosive gases is therefore critical. However, as corrosive gases must be stored in some form of container, the risk of corrosion is always present. The storing of gases, such as hazardous gases, often is in the form of compressed gas such as within a compressed gas cylinder where pressures can exceed 3000psi. This compresses the gas to improve the efficiency of transport and storage of the gas. However, corrosive gases under significant pressure invariably include risks such as leaks from corrosion of the gas cylinder. Further, many applications do not require gases to be at high pressure, and high pressure gas supplies can be detrimental to various types of work that uses gases such as corrosive gases.

There are many scientific and industrial applications that involve the use of corrosive gases. These can include material reactivity studies, production of various commercial products (e.g., solar panels), etching of circuit boards and semiconductors, etc. These applications generally do not require the corrosive gas to be supplied at high pressure, such that a low pressure gas source is preferable for use. However, low pressure gases take up large volumes of space and cannot be transported efficiently.

### BRIEF SUMMARY

Embodiments provided herein include a system and method that allows for the dispensing of corrosive gases into a vessel at low pressures. Embodiments include a system for low pressure gas regulation comprising: a bladder for receiving a gas; a vessel bounding the bladder on at least two sides; at least one sensor disposed between the bladder and at least one of the at least two sides of the vessel; a controller, where the controller is configured to receive a signal from the at least one sensor, and in response to the signal, control flow from a gas source into the bladder and to stop flow from the gas source into the bladder in response to a pressure of the gas within the bladder satisfying a predetermined threshold.

According to some embodiments the at least one sensor includes at least one of a pressure plate or a load cell. According to certain embodiments the pressure of the gas within the bladder is determined based on a pressure exerted between the bladder and the at least one of the at least two sides of the vessel detected by the at least one sensor. The system of an example embodiment further includes a solenoid, where the solenoid controls flow from the gas source into the bladder based on a signal from the controller.

According to some embodiments the solenoid comprises a manual bypass switch, where a user can control flow from the gas source into the bladder manually. The system of some embodiments further includes a pressure reducer between the gas source and the bladder to reduce a pressure of the gas before it reaches the bladder. According to certain embodiments the pressure reducer is integrated into the solenoid. According to some embodiments the predetermined threshold is a pressure of less than 0.1 pound per square inch gauge. According to certain embodiments the bladder is configured to take a shape of an inside of the vessel when the bladder is filled with the gas. The gas of an example embodiment is a corrosive gas.

Embodiments provided herein include a method for storing low pressure gas including: receiving a gas within a bladder at least partially confined within a vessel; pressing the bladder against at least one wall of the vessel based on a pressure of the gas within the bladder; receiving, at a controller, a signal from at least one sensor disposed between the bladder and the at least one wall of the vessel; and controlling, with the controller, gas flow from a gas source into the bladder based on the signal from the at least one sensor disposed between the bladder and the at least one wall of the vessel.

According to some embodiments, the at least one sensor comprises at least one of a pressure plate or a load cell. The method of some embodiments further includes determining the pressure of the gas within the bladder based on a pressure exerted between the bladder and the at least one of the at least one wall of the vessel detected by the at least one sensor. According to certain embodiments, controlling, with the controller, gas flow from a gas source into the bladder based on the signal from the at least one sensor disposed between the bladder and the at least one wall of the vessel includes: controlling, with the controller, gas flow from a gas source into the bladder using a solenoid disposed between the bladder and the gas source based on the signal from the at least one sensor disposed between the bladder and the at least one wall of the vessel.

According to certain embodiments, the solenoid includes a manual bypass switch, wherein a user can control flow from the gas source into the bladder manually. The method of some embodiments further includes reducing a pressure of the gas before it reaches the bladder using a pressure reducer between the gas source and the bladder. According to some embodiments the pressure reducer is integrated into the solenoid. According to certain embodiments, the pressure of the gas within the bladder is a pressure of less than 0.1 pound per square inch gauge. According to some embodiments the bladder is configured to take a shape of an inside of the vessel when the bladder is filled with the gas. The gas of some embodiments is a corrosive gas.

### BRIEF DESCRIPTION OF DRAWINGS

Having thus described certain embodiments of the present disclosure in general terms, reference will now be made to the accompanying drawings, which are not necessarily drawn to scale, and wherein:

FIG. 1 illustrates a block diagram of a system that allows for the dispensing of corrosive gases into a vessel at low pressures according to an example embodiment of the present disclosure;

FIG. 2 illustrates a controller for controlling a system that allows for the dispensing of corrosive gases into a vessel at low pressures according to an example embodiment of the present disclosure; and

FIG. 3 is a flowchart of a method that allows for the dispensing of corrosive gases into a vessel at low pressures according to an example embodiment of the present disclosure.

### DETAILED DESCRIPTION

The present disclosure now will be described more fully hereinafter with reference to the accompanying drawings, in which some, but not all embodiments are shown. Indeed, this disclosure may be embodied in many different forms and should not be construed as limited to the embodiments set forth herein; rather, these embodiments are provided so that this disclosure will satisfy applicable legal requirements. Like numbers refer to like elements throughout.

Low pressure gas regulation below around one pound per square inch is difficult and even more so with corrosive gases. Embodiments provided herein include a system that allows for the dispensing of corrosive gases into a vessel at low pressures. While embodiments are primarily described with respect to corrosive gases given their unique challenges, embodiments can be employed for any type of gas while achieving similar advantages. Any vessel may be configured or used to receive the case. According to an example embodiment described herein, a walled bladder or bag is configured to receive the low-pressure gas therein. Corrosive gases, as described herein, can include, for example, hydrogen chloride, chlorine, nitrogen dioxide, ammonia, or the like. The term "corrosive gases" as described herein relates to corrosive gases that are more corrosive than a typical atmospheric gas, such as oxygen in concentrations found in ambient air.

Production, transport, and storage of gases such as corrosive gases generally benefits from compressing the gases under high pressure (e.g., greater than 500psi) and storing the compressed gas in an appropriate container such as a compressed gas cylinder. Compressed gas cylinders and other high-pressure gas containers are suitable for transport and storage, but are not conducive to use of the stored gas at working pressures, which may be much lower (e.g., under 10psi) and often significantly lower (e.g., under 0.1psi). Embodiments provide herein include a system that receives gas from a gas source that can include a high pressure gas source, reduces the pressure of the gas, and stores the gas at a low pressure where it is more conducive to working pressures.

The pressure in the bladder can be used to control a gas solenoid that is used to fill the bladder. A load cell can sense the pressure in the bladder through one of the bladder walls. The load cell logic can be programmed such that the solenoid is normally closed at any pressure below a target value that assures that the bladder has integrity. According to one embodiment, the solenoid is closed at less than 0.01psi. According to other embodiments, a different pressure value can be used. The solenoid controls a valve attached to a gas tank and only opens the valve at pressures between this minimum set point and a maximum set pressure, such as 0.03psi, for example. The system may be configured with a separate manual bypass that enables the solenoid to fill the bladder to the initial pressure value. Such a manual bypass may include a manual-only dead man switch, for example.

Handling of corrosive gases is challenging given their ability to corrode vessels and containers. Corrosive gases may be used at low pressure in various industrial and scientific applications where controlled release and reaction of the corrosive gases are critical. For example, processes in industrial and scientific applications that require the use of corrosive gases may also require a low-toxicity environment and/or the ability to finely tune the reaction rate of material exposed to the corrosive gases. Low pressure corrosive gases may be employed in the field of etching of semiconductors since precise, localized reaction is required for the process. Maintaining corrosive gases at low pressure can also reduce a concentration of the corrosive gas rendering the gas less toxic.

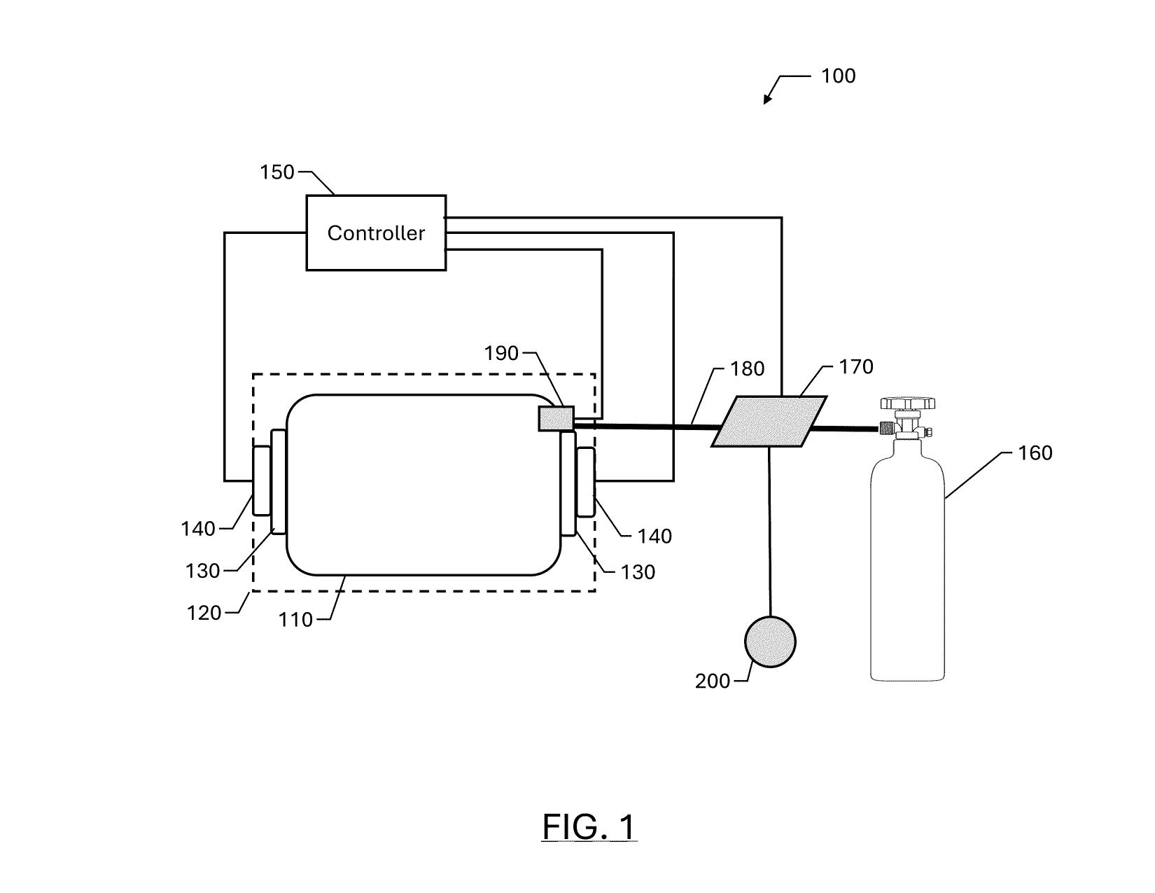

FIG. 1 illustrates an example embodiment of the system 100 described herein for low pressure bladder control that is particularly useful for handling hazardous gases. Flow control of gasses at low pressure is challenging and can be critically important when handling corrosive gases. FIG. 1 depicts a system to address these challenges and to enable precise control of low pressure gas flow to a bladder 110 that is disposed within a vessel 120. The bladder 110 of an example embodiment is a bladder that is highly flexible such as a plastic film and configured to receive the low-pressure gas. The vessel 120 can include at least a semi-rigid material such as a plastic of sufficient thickness, metal, composite, or the like. Generally, the vessel 120 will not directly contact the corrosive gas such that the corrosive nature of the material used for the vessel 120 may be considered only in view of potential system leaks (e.g., from the bladder 110) or within the general environment in which the vessel 120 is housed.

Within the vessel 120 is one or more pressure plates 130 and one or more load cells 140 between the bladder 110 and an inner wall of the vessel 120. The pressure plates 130 and load cell 140 can be separate or integrated with one another. The pressure plate 130 is configured to amplify the pressure signal to the load cell by increasing an area over which the pressure of the bladder 110 is acting. While the example embodiment depicts a pressure plate 130 and load cell 140 on opposite ends of the bladder 110 within the vessel 120, embodiments could optionally employ a single pressure plate 130 and load cell 140. The one or more load cells 140 are in electrical communication with a controller 150. The one or more load cells 140 provide signals to the controller 150 based on the pressure seen at the one or more pressure plates 130 and measured at the load cells.

FIG. 1 also includes a gas source 160 that is plumbed to a solenoid 170, where the solenoid is plumbed via line 180 to the bladder 110, such as via a pressure transducer 190. As gas enters the bladder 110 from the gas source 160, the pressure in the bladder builds. The one or more load cells 140 provide sensor readings to the controller which identifies the pressure within the bladder. Pressure transducer 190 can similarly provide pressure feedback of the pressure within the bladder to the controller 150. The controller 150 controls the solenoid 170 which either allows gas from the gas source 160 to enter the bladder 110 or ceases flow from the gas source. Thus, the controller 150 can precisely control the pressure of the gas within the bladder. This method of control enables the bladder 110 to maintain a very low pressure of the gas at a precise pressure. The gas within the bladder 110 can then be supplied to any necessary destination, such as for various industrial and scientific applications.

According to the embodiment of FIG. 1, the solenoid 170 further includes a manual bypass switch 200 that enables an operator to control the solenoid to open and permit gas flow from the gas source 160 into the bladder 110. The solenoid 170 and/or the pressure transducer 190 can function to be a pressure reducing valve to reduce the pressure from the gas source 160 before reaching the bladder 110. The gas source 160 may contain gas under a considerably higher pressure than that of the bladder 110, such that a pressure drop across the solenoid 170 and/or the pressure transducer 190 can help stem the flow of gas and reduce chances of overfilling the bladder 110.

To fill or replenish gas within the bladder 110, the one or more pressure plates 130 and/or one or more load cells 140 may provide a signal to the controller 150 that the bladder pressure is below a predetermined threshold above which the bladder is to be maintained. For example, when the pressure within the bladder 110 drops below 0.01psig (Pounds per Square Inch Gauge, or above ambient pressure), the controller 150 may command the solenoid 170 to open, permitting gas flow from the gas source 160 to the bladder 110 via the solenoid. This flow of gas may continue until the pressure within the bladder is determined by the controller 150, such as using the one or more pressure plates 130 and/or one or more load cells 140, to have reached a desired pressure or setpoint pressure (e.g., 0.03psig). The controller 150 then commands the solenoid 170 to close, ceasing flow of gas from the gas source 160 to the bladder 110.

The container, described as a bag or bladder is a container and these terms will be used often as the container. A bladder of an embodiment defines a shape and volume prescribed not only by the outer bladder material, but also by the vessel 120 within which the bladder 110 is contained. The bladder may be any shape and dimension and may have a top layer secured to a bottom layer at the edges with an internal structure of ribbing that limits the separation of the top layer and the bottom layer between the edges or perimeter. Optionally, the ribbing or internal structure can be formed by attaching a portion of the top layer to a portion of the bottom layer, such as along a seam, to form chambers. Forming the bladder as described herein provides structure and rigidity to the bladder without requiring a frame, thus reducing cost, weight, and complexity of the bladder as compared to prior iterations. This configuration of the bladder can dictate the dimensions of expansion when the bladder is pressurized with gas. The dimensions of expansion can be used to place the one or more pressure plates or load cells as needed to measure the pressure within the bladder as described above.

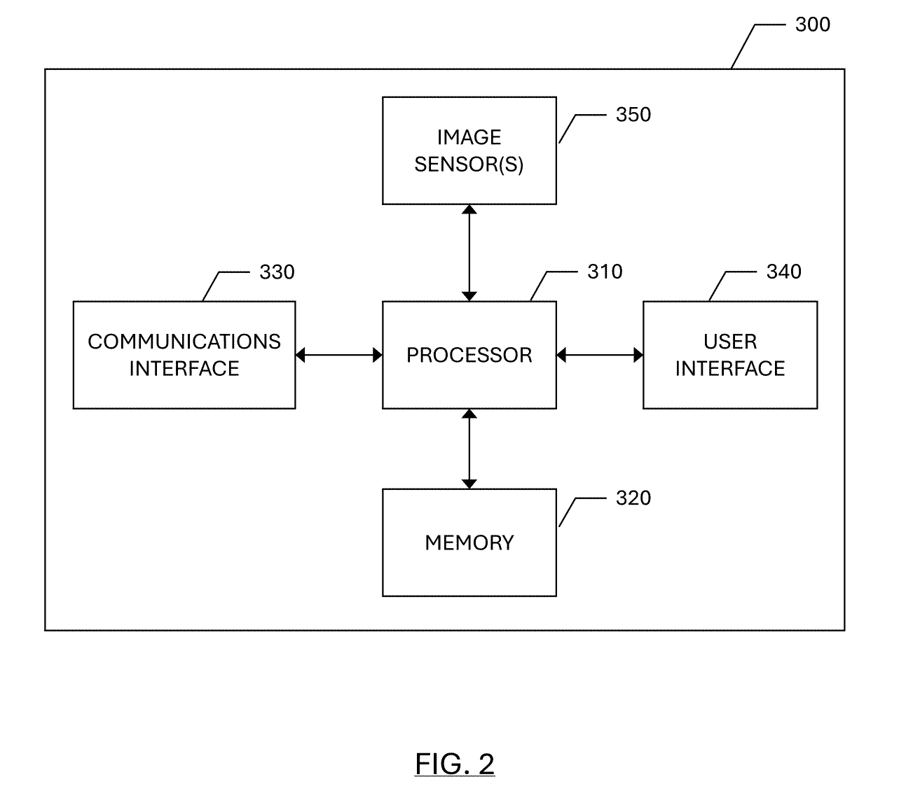

FIG. 2 is a schematic diagram of an example of a controller 300 that may be used to control the pressure within a bladder as described above. The controller 300 may include or otherwise be in communication with a processor 310, a memory 320, a communication interface 330 and a user interface 340. As such, in some embodiments, although devices or elements are shown as being in communication with each other, hereinafter such devices or elements should be considered capable of being embodied within the same device or element and thus, devices or elements shown in communication should be understood to alternatively be portions of the same device or element.

In some embodiments, the processor 310 (and/or co-processors or any other processing circuitry assisting or otherwise associated with the processor) may be in communication with the memory 320 via a bus for passing information among components of the apparatus. The memory 320 may include, for example, one or more volatile and/or non-volatile memories. In other words, for example, the memory 320 may be an electronic storage device (e.g., a computer readable storage medium) comprising gates configured to store data (e.g., bits) that may be retrievable by a machine (e.g., a computing device like the processor). The memory 320 may be configured to store information, data, content, applications, instructions, or the like for enabling the sensors 350 (e.g., load cells, pressure plates, pressure transducer, etc.) to carry out various functions in accordance with an example embodiment of the present disclosure. For example, the memory 320 could be configured to buffer input data for processing by the processor 310. Additionally (or alternatively), the memory 320 could be configured to store instructions for execution by the processor, such as for controlling the sensors 350 described above.

The processor 310 may be embodied in a number of different ways. For example, the processor 310 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally (or alternatively), the processor 310 may include one or more processors configured in tandem via the bus to enable independent execution of instructions, pipelining and/or multithreading. The processor may be embodied as a microcontroller having custom bootloader protection for the firmware from malicious modification in addition to allowing for potential firmware updates.

In an example embodiment, the processor 310 may be configured to execute instructions stored in the memory 320 or otherwise accessible to the processor 310. Alternatively (or additionally), the processor 310 may be configured to execute hard coded functionality. As such, whether configured by hardware or software methods, or by a combination thereof, the processor 310 may represent an entity (e.g., physically embodied in circuitry) capable of performing operations according to an embodiment of the present disclosure while configured accordingly. Thus, for example, when the processor 310 is embodied as an ASIC, FPGA or the like, the processor 310 may be specifically configured hardware for conducting the operations described herein. Alternatively, as another example, when the processor 310 is embodied as an executor of software instructions, the instructions may specifically configure the processor 310 to perform the algorithms and/or operations described herein when the instructions are executed. However, in some cases, the processor 310 may be a processor of a specific device configured to employ an embodiment of the present disclosure by further configuration of the processor 310 by instructions for performing the algorithms and/or operations described herein. The processor 310 may include, among other things, a clock, an arithmetic logic unit (ALU) and logic gates configured to support operation of the processor 310. In one embodiment, the processor 310 may also include user interface circuitry configured to control at least some functions of one or more elements of the user interface 340.

The communication interface 330 may include various components, such as a device or circuitry embodied in either hardware or a combination of hardware and software that is configured to receive and/or transmit data. In this regard, the communication interface 330 may include, for example, an antenna (or multiple antennas) and supporting hardware and/or software for enabling communications wirelessly. Additionally (or alternatively), the communication interface 330 may include the circuitry for interacting with the antenna(s) to cause transmission of signals via the antenna(s) or to handle receipt of signals received via the antenna(s). For example, the communication interface 430 may be configured to communicate wirelessly such as via Wi-Fi (e.g., vehicular Wi-Fi standard 802.1 lp), Bluetooth, mobile communications standards (e.g., 3G, 4G, or 5G) or other wireless communications techniques. In some instances, the communication interface may alternatively or also support wired communication, which may communicate with a separate transmitting device (not shown).

The user interface 340 may be in communication with the processor 310, such as the user interface circuitry, to receive an indication of a user input and/or to provide an audible, visual, mechanical, or other output to an operator. As such, the user interface 340 may include, for example, one or more buttons, light-emitting diodes (LEDs), a mounted display, a speaker, and/or other input/output mechanisms. The user interface 340 may also be in communication with the memory 320 and/or the communication interface 330, such as via a bus.

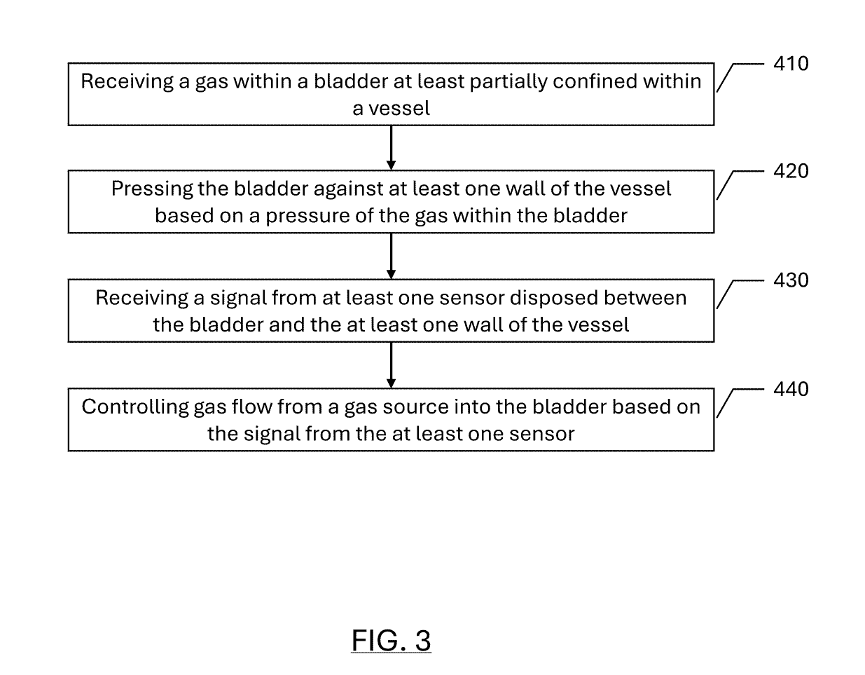

FIG. 3 illustrates a flowchart depicting methods according to an example embodiments of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 320 of an apparatus employing an embodiment of the present invention and executed by a processor 310 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

FIG. 3 illustrates a flowchart of a method for method that allows for the dispensing of corrosive gases into a vessel at low pressures. As shown, a gas is received within a bladder that is at least partially confined within a vessel at 410. The bladder is pressed against at least one wall of the vessel based on a pressure of the gas within the bladder at 420. This may generate a signal at a sensor (e.g., sensor 350). A signal from at least one sensor disposed between the bladder and the at least one wall of the vessel is received at 430, such as at a controller 300 via communications interface 330. At 440, gas flow from a gas source into the bladder is controlled (e.g., by controller 300) based on the signal from the at least one sensor.

In an example embodiment, an apparatus for performing the method of FIG. 3 above may comprise a processor (e.g., the processor 310) configured to perform some or each of the operations (410-440) or portions thereof described above. The processor may, for example, be configured to perform the operations (410-440) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 410-440 may comprise, for example, the processor 410 and/or a device or circuit for executing instructions or executing an algorithm for processing information as described above.

Many modifications and other embodiments of the disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for low pressure gas regulation comprising: a bladder for receiving a gas; a vessel bounding the bladder on at least two sides; at least one sensor disposed between the bladder and at least one of the at least two sides of the vessel; a controller, wherein the controller is configured to receive a signal from the at least one sensor, and in response to the signal, control flow from a gas source into the bladder and to stop flow from the gas source into the bladder in response to a pressure of the gas within the bladder satisfying a predetermined threshold.

2. The system of claim 1, wherein the at least one sensor comprises at least one of a pressure plate or a load cell.

3. The system of claim 2, wherein the pressure of the gas within the bladder is determined based on a pressure exerted between the bladder and the at least one of the at least two sides of the vessel detected by the at least one sensor.

4. The system of claim 1, further comprising a solenoid, wherein the solenoid controls flow from the gas source into the bladder based on a signal from the controller.

5. The system of claim 4, wherein the solenoid comprises a manual bypass switch, wherein a user can control flow from the gas source into the bladder manually.

6. The system of claim 4, further comprising a pressure reducer between the gas source and the bladder to reduce a pressure of the gas before it reaches the bladder.

7. The system of claim 6, wherein the pressure reducer is integrated into the solenoid.

8. The system of claim 1, wherein the predetermined threshold is a pressure of less than 0.1 pound per square inch gauge.

9. The system of claim 1, wherein the bladder is configured to take a shape of an inside of the vessel when the bladder is filled with the gas.

10. The system of claim 1, wherein the gas comprises a corrosive gas.

11. A method for storing low pressure gas comprising: receiving a gas within a bladder that is at least partially confined within a vessel; pressing the bladder against at least one wall of the vessel based on a pressure of the gas within the bladder; receiving, at a controller, a signal from at least one sensor disposed between the bladder and the at least one wall of the vessel; and controlling, with the controller, gas flow from a gas source into the bladder based on the signal from the at least one sensor disposed between the bladder and the at least one wall of the vessel.

12. The method of claim 11, wherein the at least one sensor comprises at least one of a pressure plate or a load cell.

13. The method of claim 12, further comprising: determining the pressure of the gas within the bladder based on a pressure exerted between the bladder and the at least one of the at least one wall of the vessel detected by the at least one sensor.

14. The method of claim 11, wherein controlling, with the controller, gas flow from a gas source into the bladder based on the signal from the at least one sensor disposed between the bladder and the at least one wall of the vessel comprises: controlling, with the controller, gas flow from a gas source into the bladder using a solenoid disposed between the bladder and the gas source based on the signal from the at least one sensor disposed between the bladder and the at least one wall of the vessel.

15. The method of claim 14, wherein the solenoid comprises a manual bypass switch, wherein a user can control flow from the gas source into the bladder manually.

16. The method of claim 14, further comprising reducing a pressure of the gas before it reaches the bladder using a pressure reducer between the gas source and the bladder.

17. The method of claim 16, wherein the pressure reducer is integrated into the solenoid.

18. The method of claim 11, wherein the pressure of the gas within the bladder is a pressure of less than 0.1 pound per square inch gauge.

19. The method of claim 11, wherein the bladder is configured to take a shape of an inside of the vessel when the bladder is filled with the gas.

20. The method of claim 11, wherein the gas comprises a corrosive gas.
